(19) United States
(12) Patent Application Publication
(10) Pub. No.: US 2010/0062395 A1
(43) Pub. Date: Mar. 11, 2010

(54) DEVICE PROVIDING AN INTERFACE BETWEEN A DENTAL IMPLANT AND AN ABUTMENT

(75) Inventors: Eliezer Bar Shalom, Nir Galim (IL); Eitan Avniel, Lapid (IL)

Correspondence Address: The Law Office of Michael E. Kondoudis, 888 16th Street, N.W., Suite 800, Washington, DC, 20006, US

(73) Assignee: A.B. DENTAL DEVICES LTD., Nir Galim (IL)

(21) Appl. No.: 12/530,262

(22) PCT Filed: Mar. 12, 2008
(86) PCT No.: PCT/IL2008/000342

§ 371 Date: Sep. 8, 2009

Related U.S. Application Data
(60) Provisional application No. 60/918,036, filed on Mar. 15, 2007.

(51) Int. Cl. A61C 8/00

(52) U.S. Cl. 433/173

(57) ABSTRACT

A system comprising a dental interface device and a dental implant. The interface device provides an interface between a dental abutment and the implant allowing connecting the implant to the abutment. The interface device may comprise a shank and a polygonal connector, where the connector extends from one end of the shank. The connector may comprise sections forming the polygonal shape where the implant may comprise a polygonal receptacle, which is a cavity designed to receive the polygonal connector of the interface device. The outer dimensions of the connector may be slightly larger than the corresponding inner dimensions of the polygonal receptacle. The sections can bend inwardly towards the center of the connector when inserted to the receptacle, and return to an unbent position once the connector is inside the receptacle, thereby applying pressure upon the inner walls of the receptacle, thereby securing said connector to the receptacle and implant.

### CROSS REFERENCE TO RELATED APPLICATION

This application is a National Stage of an international application No. PCT/IL2008/000342, filed Mar. 12, 2008, which is incorporated herein by reference in its entirety, which in turn claimed the benefit of U.S. Provisional Patent Application 60/918,036, filed Mar. 15, 2007, which is incorporated by reference herein.

### FIELD OF THE INVENTION

The present invention, in some embodiments thereof, relates generally to the field of dental implants and more particularly, the present invention relates to dental interface devices for corresponding dental implants.

### BACKGROUND OF THE INVENTION

Dental implant systems, allowing endosseous implanting of artificial teeth in a patient's mouth, usually comprise two main components: (i) a dental implant, which is the part (usually made from titanium) that is endesseously transplanted in the jawbone of the patient (replacing the tooth root) and (ii) a dental abutment, which is a tooth or tooth structure which is responsible for the anchorage of a bridge or a denture. The abutment is fastened to the upper part of the implant. Many of these means for fastening are nondurable or do not secure the implant to the abutment well enough.

U.S. Pat. No. 5,281,140, which is incorporated herein by reference, discloses a multi-part abutment adapted for use with dental implants. This abutment has an internal opening or passage with an internal, non-circular shape at the top that includes two parts: part one, that sealingly engages the opening or passage in the top of the implant at the bottom end of part one, and engages another abutment part, part two, at the top end of part one through a multi-sided projection. Part two has at its bottom end a multi-sided cavity that fits the multi-sided projection from part one so that part two can be seated in a plurality of positions atop part one.

U.S. Pat. No. 5,281,140, which is incorporated herein by reference, discloses a dental implant system that includes a dental implant having a multi-sided projection at its top end and an internally threaded or unthreaded passage extending into the body of the implant through an opening in the projection at the top of the implant, and an abutment having an internal passage for receiving a fastener that passes through the internal passage of the abutment, and threads into the internal passage inside the implant. The abutment has a multi-sided internal cavity at its bottom end with each of the cavity sides perpendicular to the longitudinal axis of the abutment so that the cavity, when seated over the projection at the top of the implant, forms an anti-rotational, interlocking junction with the implant.

Both of the aforementioned patents allow interlocking the protruding part of the abutment with the receiving cavity of the implant by fitting the shape of the protrusion to the shape of the cavity walls. The fitting shapes (of the cavity and the protrusion) may allow interlocking the rotational movement of the protrusion around the main axis coaxially shared by the implant cavity and the abutment protrusion, but it may not prevent a longitudinal movement of the abutment, which may loosen the fastening of the abutment to the implant and lead to uncomfortable and unhealthy results when installed in a patient's mouth.

### SUMMARY OF THE INVENTION

The present invention, in some embodiments thereof, is directed to a system comprising a dental interface device and a dental implant. The dental interface device provides an interface between the dental implant and a corresponding dental abutment, which is a tooth or tooth structure which is responsible for the anchorage of a bridge or a denture.

According to some embodiments of the invention, the interface device may comprise a shank and a polygonal connector, where the connector may be integrally formed with the shank and extend from one end of the shank. The connector may comprise sections forming the polygonal shape where the dental implant may comprise a corresponding polygonal receptacle, which is a cavity designed to receive the polygonal connector of the interface device. The outer dimensions of the connector may be slightly larger than the corresponding inner dimensions of the polygonal receptacle. The sections can bend inwardly towards the center of the connector when inserted to the receptacle, and return to an unbent position once the connector is inside the receptacle, thereby applying pressure upon the inner walls of the receptacle, thereby securing said connector to the receptacle and implant.

According to some embodiments of the invention, the sections of the connector may be divided by cuts separating one section from an adjacent section.

Alternatively, the cut separating each section from another adjacent section may run from the corner of the connector and does not reach the base of the shank.

According to some embodiments of the invention, at least part of the implant may be made from titanium (e.g. the part that is endosseous implanted into the patient's jawbone).

According to some embodiments of the invention, the system may additionally comprise a tightening element facilitating in further securing the interface device to the implant's receptacle. The tightening element may be a longitudinal object comprising a substantially conical taper, where each section of the interface device may correspondingly comprise at least one projection allowing to interlock with said taper.

According to some embodiments of the invention, the interface device may additionally comprise a longitudinal cavity allowing insertion of said element into said longitudinal cavity in such a way that when securing the tightening element into said cavity and into the receptacle of said implant the taper slides over the projections thereby causing the projections to be pressed against the inner walls of the sections and hence further pressing the sections against the inner walls of the receptacle whereby the tightening element is fastened to the interface device and whereby said interface device is fastened to said implant's receptacle.

According to some embodiments of the invention, the interface device may enable attaching to a dental abutment through means for fastening such as screwing means, gluing, and the like, as known in the art.

According to some embodiments of the invention, the sections of the interface device may be made from flexible solid material enabling the slight bending of said section as well as the retrieving of said sections to the unbent position.

Additionally, the material from which the sections are made may have a substantially roughened surface to facilitate in increasing the friction between the connector and the inner walls of the implant's receptacle such as, for example, rubber, polymeric flexible and roughened materials, silicone and the like.

According to some embodiments of the invention, the system may additionally comprise an extricating tool especially adapted to the interface device configuration, where said tool may enable detaching of the interface device from the implant. The extricating tool may be, for example, an extricating bolt, screwdriver, pliers, a grasper, and the like.

According to some embodiments of the invention, the cut separating each section from another adjacent section may run from the corner of the connector towards the base of the shank.

Additionally, the outer surface of the sections may be tilted (e.g. by being chamfered) creating a non-flat angle between each section of said device and the main axis of said device to facilitate in inserting of said device's connector to said implant's receptacle.

According to some embodiments of the invention, the interface device may be integrally configured with a dental abutment.

According to some embodiments of the invention, the dental implant may be an endosseous implant placed within the patient's bone.

According to some embodiments of the invention, the process of coupling of a dental interface device of an abutment to a dental implant may involve inserting of the polygonal connector into the cavity of the receptacle, where upon insertion the sections of the connector are bent towards the main axis of the connector allowing the insertion. The connector's sections may enable retrieving to an unbent position once the connector is inside the receptacle, where the outer walls of the sections of the connector apply pressure against the inner walls of the receptacle securing the connector to the implant.

According to some embodiments of the invention, the dental implant may already be endosseously seated in the patient's jawbone when the interface device is inserted into the implant's receptacle.

### BRIEF DESCRIPTION OF THE DRAWINGS

The subject matter regarded as the invention will become more clearly understood in light of the ensuing description of embodiments thereof, given by way of example only, with reference to the accompanying figures, wherein:

FIG. 1A is a schematic illustration of an exploded view of a dental abutment and an interface device affixed to a receptacle of a dental implant, according to an embodiment of the invention;

FIG. 1B is another schematic cross-sectional illustration of the connector including an indication of the forces that said connector applies on the inner wall of the receptacle;

FIG. 2A is a schematic illustration of an exploded view of the abutment and the interface device according to an embodiment of the invention;

FIG. 2B is a schematic cross-sectional illustration of the connector of the interface device and the forces that are applied on the connector when being forced into the receptacle, according to an embodiment of the invention;

FIG. 3A is a schematic side view of the interface device according to an embodiment of the invention;

FIG. 3B is another isometric illustration of the interface device according to an embodiment of the invention;

FIG. 4 is a schematic exploded side view of an affixing screw when being inserted into the interface device, according to an embodiment of the invention;

FIG. 5 is a schematic illustration of an interface device, according to other embodiments of the invention;

FIG. 6 is a schematic illustration of an interface device with tilted sections, according to other embodiments of the invention;

FIG. 7 is a schematic illustration of an interface device adapted to receive an extricating tool, according to some embodiments of the invention; and

FIG. 8 is a flowchart illustrating a method for coupling of a dental interface device of an abutment to a dental implant, according to some embodiments of the invention.

The drawings together with the description make apparent to those skilled in the art how the invention may be embodied in practice.

### DETAILED DESCRIPTION OF SOME EMBODIMENTS OF THE INVENTION

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions.

It is understood that the phraseology and terminology employed herein is not to be construed as limiting and is for descriptive purpose only.

The principles and uses of the teachings of the present invention may be better understood with reference to the accompanying description, figures and examples.

It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, integers or groups thereof and that the terms are not to be construed as specifying components, features, steps or integers.

The phrases “consisting essentially of”, and grammatical variations thereof, when used herein are not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element.

It is to be understood that where the claims or specification refer to “a” or “an” element, such reference is not to be construed as there being only one of that element.

It is to be understood that where the specification states that a component, feature, structure, or characteristic “may”, “might”, “can” or “could” be included, that particular component, feature, structure, or characteristic is not required to be included.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

The terms “bottom”, “below”, “top” and “above” as used herein do not necessarily indicate that a “bottom” component is below a “top” component, or that a component that is “below” is indeed “below” another component or that a component that is “above” is indeed “above” another component. As such, directions, components or both may be flipped, rotated, moved in space, placed in a diagonal orientation or position, placed horizontally or vertically, or similarly modified. Accordingly, it will be appreciated that the terms “bottom”, “below”, “top” and “above” may be used herein for exemplary purposes only, to illustrate the relative positioning or placement of certain components, to indicate a first and a second component or to do both.

The present invention discloses a system 1000 and a dental interface device 100 that provides an interface between a dental abutment 200 and a dental implant 150. According to some embodiments of the invention, the interface device 100 may comprise a shank 110 and a polygonal connector 120 that tightly fits into a corresponding polygonal receptacle 151 of the implant 150, which has a cavity of the same polygon as the connector 120 (meaning the same number of sides), designed to receive the polygonal connector 120. The shank 110 may be attached to the connector 120 or integrally formed.

According to some embodiments of the invention the dental implant 150 may be an endosseous implant (also known in the art as an endosteal implant), which is a dental implant consisting of a blade, screw, pin, or vent, inserted into the jaw bone of a (human) patient through the alveolar or basal bone, with a post protruding through the mucoperiosteum into the oral cavity to serve as an abutment for dentures or orthodontic appliances, or to serve in fracture fixation.

An abutment 200 is a tooth-shaped cap that is mounted upon the dental implant 150, where most of the implant 150 is seated inside the gum tissue and the abutment 200 protrudes outwardly allowing supporting adjacent dentures or orthodontic appliances.

According to some embodiments of the invention, the edge of the interface device 100 that is the connector 120 may be inserted to the implant's 150 receptacle 151 to connect the device 100 to the implant 150, where the other edge of the interface device 100 may be connected to or integrally configured with the dental abutment 200. The connection between the abutment 200 and the interface device 100 may be any connecting mechanism that is or that will be known in the art.

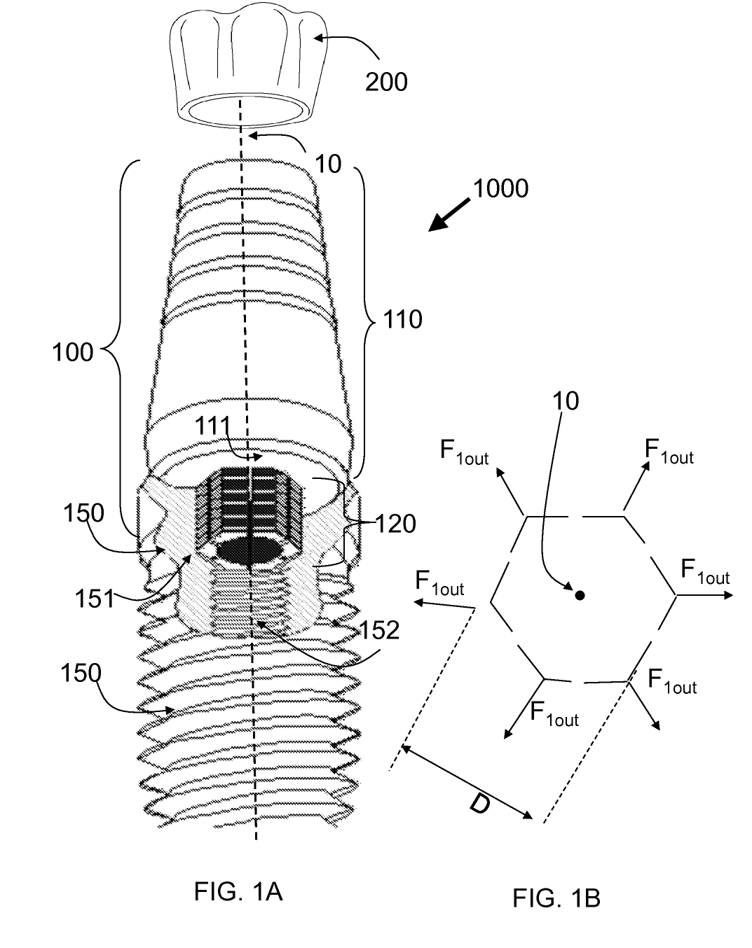

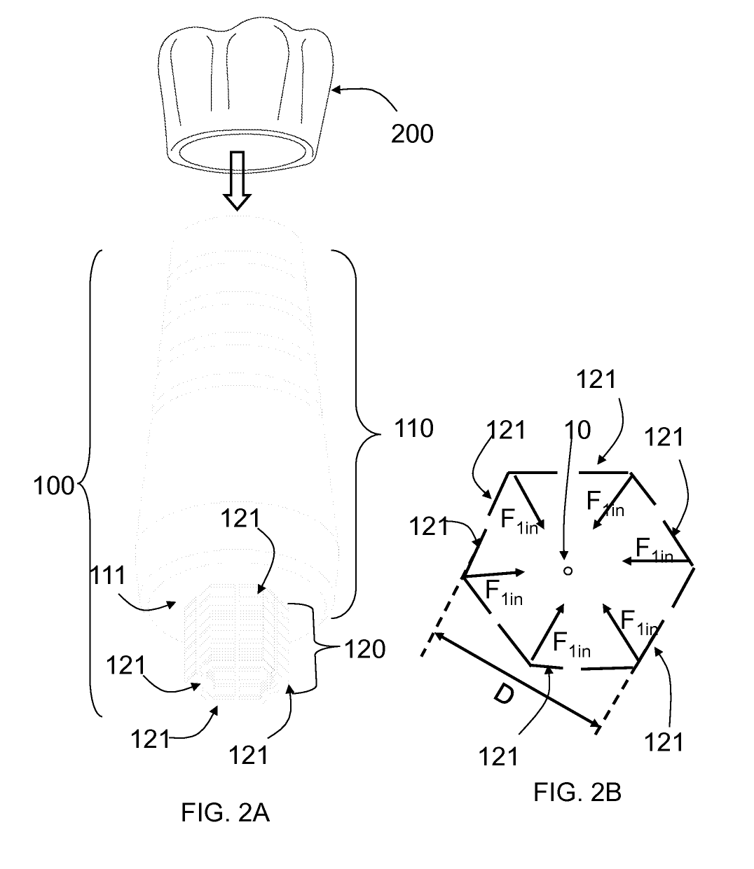

According to some embodiments of the connector 120 may comprise sections 121 (FIG. 2A), which may be pieces that are made from slightly flexible solid materials, creating the polygonal shape of the connector 120. The connector's 120 dimensions “D”, as illustrated in FIGS. 1B and 2Bb, which are the cross-section surface and shape, may be slightly larger than the corresponding cross-sectional surface area of the receptacle 151. The sections 121 may allow slightly bending (or any other type of elastic deformation) towards the main axis 10 of the interface device 100 (which is the same main axis 10 of the implant's 150 receptacle 151, as illustrated in FIG. 1A and FIG. 1B) to allow inserting the protruding connector 120 into the receptacle 151. Once inside the cavity of the implant's 150 receptacle 151, the sections 121 may deform back to an unbent position.

According to some embodiments of the invention, as illustrated in FIG. 1A and FIG. 1B, the sections 121 of the connector 120 may have an angular external surface. Alternatively, the sections may have a substantially flat external surface where each slice forms a side of the polygon.

Since the dimensions D of the cross sectional surface area of the connector 120 are slightly larger than those of the receptacle 151 in the unbent position, the connector's 120 sections 121 may apply pressure forces “Fₒᵤₜ”, as illustrated in FIG. 1B, pressing against the inner walls of the receptacle's 151 cavity, thereby securing the fastening or coupling of the connector 120 to the implant 150 by increasing the friction at the interface between the connector's 120 outer walls and the receptacle's 151 inner walls.

An embodiment is an example or implementation of the inventions. The various appearances of “one embodiment,” “an embodiment” or “some embodiments” do not necessarily all refer to the same embodiments.

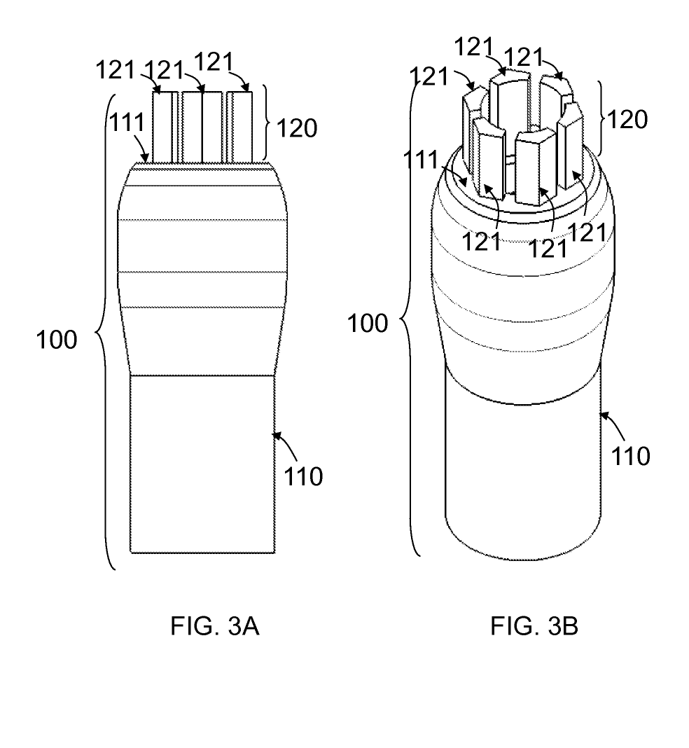

Reference is now made to FIG. 1A, FIG. 1b, FIG. 2A, FIG. 2B, FIG. 3A and FIG. 3B. According to some embodiments of the invention, an interface device 100 may comprise a shank 110 and a polygonal connector 120 extending from the base 111 of the shank 110. Connector 120 may have any type of polygonal shape. Non-limiting examples of such polygonal shapes include rectangular, pentagonal, hexagonal shapes and the like. It is to be understood that for exemplary purposes only, the connectors 120 specified hereinafter have a hexagonal cross-sectional polygonal shape. The connector 120 may be integrally formed with the shank 110 or alternatively, rigidly adjusted to the base 111 of the shank 110.

As illustrated in FIG. 1A, according to some embodiments of the invention, the polygonal connector 120 extends from the base 111 of the shank 110, and may be polygonal (such as hexagonal), having a number of sides (such as six) and a central axis 10. The polygonal connector 120 may be sectioned by cuts, which may be parallel to the axis 10, thereby forming a number of sections 121 extending from the base 111 of the shank 110 in a cantilever manner. The number of sections 121 may be equal to the number of sides of the polygonal connector 120.

According to an embodiment of the invention, as illustrated in FIG. 1A and FIG. 1B, the connector 120 may be divided into sections 121, whereby the cut of each section 121 extends vertically from the connector's 120 end towards the base 111 of the shank 110 (either reaching the base 111 or reaching a part of the line directing towards the base 111). Due to the connector's 120 sectioned configuration, each section 121 may have the ability to bend (or deform in any other manner) inwardly, as schematically indicated by arrows F₁ᵢₙ in FIG. 2B.

The connector 120 and the cavity walls of the implant's 150 receptacle 151 may be coaxial the same main axis 10 and substantially the same symmetry around the axis 10.

According to some embodiments of the invention, at least some of the outer dimensions D of the connector 120 may be, for example, slightly larger than the internal cross-sectional dimensions of the implant's 150 receptacle 151. Thus configured, the sections 121 may bend inwardly when forced into the receptacle 151. In doing so, the bent sections 121 may apply a pressure force F₁ₒᵤₜ outwards against the inner walls of the receptacle 151, thereby causing friction between sections 121 and the inner wall of the receptacle 151. As a result, the interface device 100 may be securely fastened to the receptacle 151 of the implant 150, substantially preventing pullouts caused by longitudinal forces threatening to pull the interface device 100 out of the implant 150 and therefore the abutment 200 from the implant 150. Additionally, this fastening technique based on interlocking the connector 120 by the polygonal shapes of the receptacle 151 and the connector 120 may additionally prevent rotational movements that can threat the securing of the abutment 200 to the implant 150.

According to some embodiments of the invention, a suitable affixing screw 152 may be screwed into the interface device 100 to secure the interface device 100 to the implant 150.

The deeper the connector 120 of the interface device 100 is inserted into the corresponding implant's receptacle 151, the more the top part of the sections 121 (that is adjacent to the base 111) start to bend towards the axis 10, where the resistance of the sections 121 to the bending may be designed to be higher than the low part of the sections 121 (at the edge of the connector 120). Accordingly, friction between the outer wall of the sections 121 and the inner wall of the receptacle 151 may be increased tightening the fit between the interface device 100 and the receptacle 151.

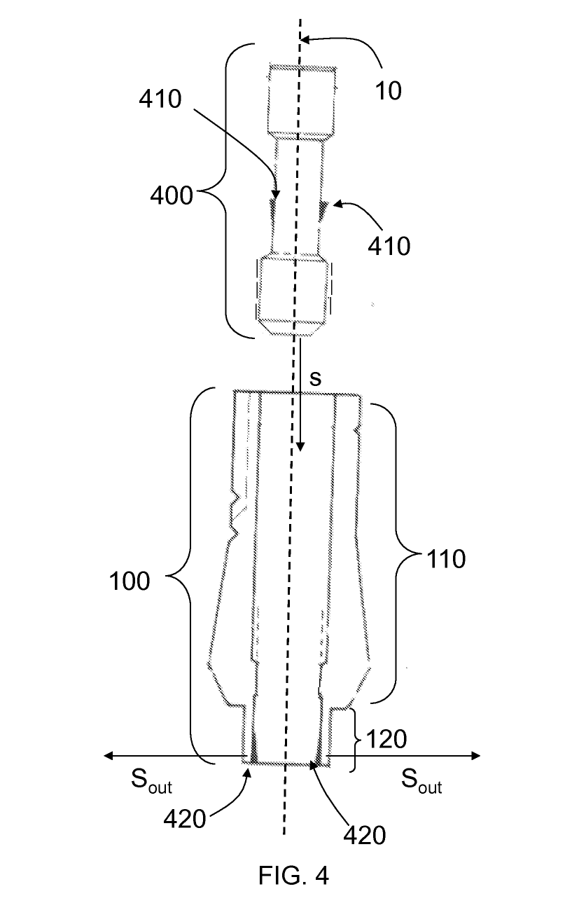

FIG. 4 schematically illustrates an exploded view of a longitudinal cross-section of the interface device 100 adapted to receive a tightening element 400, as schematically indicated with arrows “Sₒᵤₜ”, according to some additional or alternative embodiments of the invention.

According to some embodiments of the invention, the tightening element 400 may be an elongate, generally cylindrical element, having two ends and an external generally cylindrical surface. The end portions of the element 400 may have increased diameter, as illustrated in FIG. 4, and a mid-portion that has an increased diameter with a substantially conical taper 410, towards one of the ends surrounding or disposed on an exterior surface of the tightening element 400.

According to an embodiment of the invention, the interface device 100 may include complementary projections 420 situated on the outer surface of the sections 120.

According to some embodiments of the invention, the interface device 100 may additionally comprise a longitudinal cavity 425 enabling to receive the tightening element 400, as illustrated in FIG. 4. For example, the tightening element 400 may have a narrow cylindrical shape that ends with a thicker polygonal shape corresponding to the polygonal shape of the interface device's 100 longitudinal cavity 425 of the sections 121.

According to some embodiments of the invention. The taper 410 may interlock with the projections 420 in such a way that securing of the tightening element 400 over the interface device 100 into the implant 150 may cause the taper 410 to slide over the projections 420, thereby causing the projections 420 to be pressed against the inner walls of the receptacle 151, as schematically indicated with arrows Sₒᵤₜ. Therefore, the pressure between the outer walls of the sections 121 and the inner walls of the receptacle 151 is increased enabling to increase the tightening and coupling of the interface device 100 to the implant 150 hence the abutment 200 connected to the interface device to the implant 150.

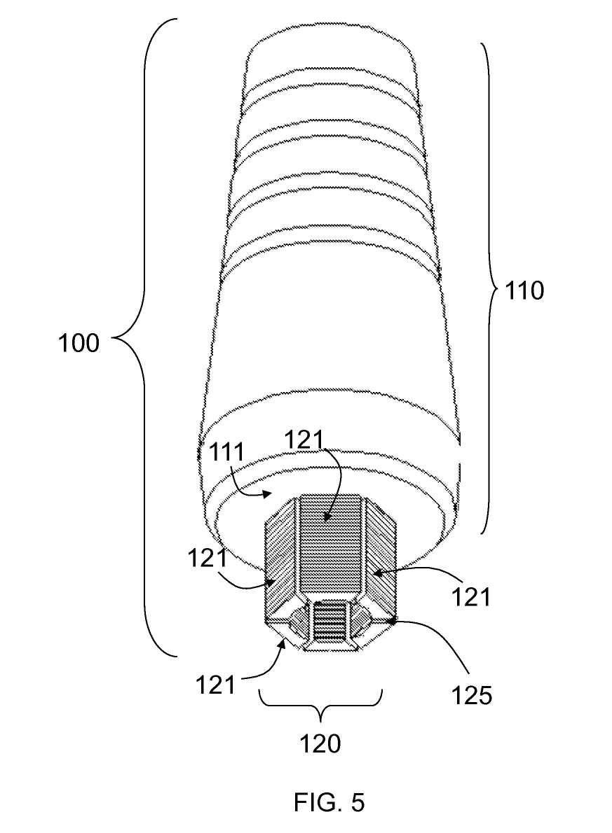

FIG. 5 is a schematic illustration of the interface device 100, according to other embodiments of the invention. According to these embodiments, the interface device 100 may comprise a connector 120 that is sectioned into sections 121, where the cut 125 separating one section 121 from another adjacent section 121 runs from the corner of the connector 120 towards the base 111 of the shank 110. The external surface of the sections 121 are substantially flat where each section 121 is a wall of the polygon.

The cuts 125 of the defining the slices 121 may extend part way or all the way. The cuts 125 can extend axially along the sides, or along the corners of the sections 121. If the cuts 125 are along the corners, then the sections 121 will have flat surfaces, as illustrated in FIG. 5. If the cuts 125 are along the sides, the sections 121 will have angled surfaces because a section 121 is part of one side and part of another adjacent side, as illustrated in FIG. 1A and FIG. 2A.

The shank 110 may be made of any suitable solid material or a mixture of solid materials known in the art such as, for example, metal, enamel, polymeric materials and the like.

The sections 121 may be made from any suitable solid material that has a slight flexibility to allow the slight bending and the retrieving of the sections 121 and/or 521 into their original unbent position. Additionally, the material from which the sections may be made may have a substantially roughened surface to facilitate in increasing the friction between the connector 120 and the inner walls of the implant's 150 receptacle 151, such as for example, rubber, rubber like polymeric materials, silicone and the like.

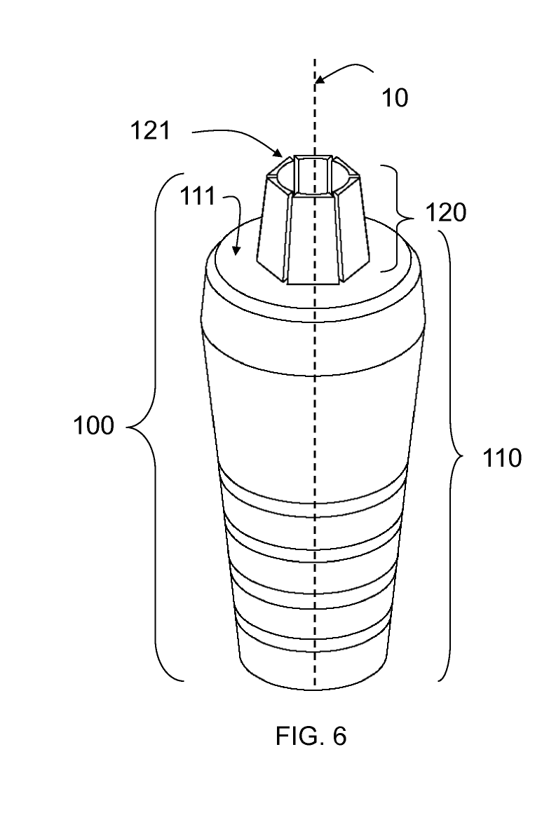

According to some embodiments of the invention, as illustrated in FIG. 6, the sections 121 (or only the inner or outer surface of the sections 121 (e.g. by being chamfered)) may be tilted either inwardly towards the main axis 10 or outwardly from the main axis 10, creating a non-straight angle between each section 121 and the main axis 10 to facilitate the inserting of the connector 120 to the receptacle 151. Once inside the implant's 150 receptacle 151, the sections 121 of the interface device 100 may apply radial forces (along the plane that is perpendicular to the main axis 10 against the inner walls of the receptacle 151.

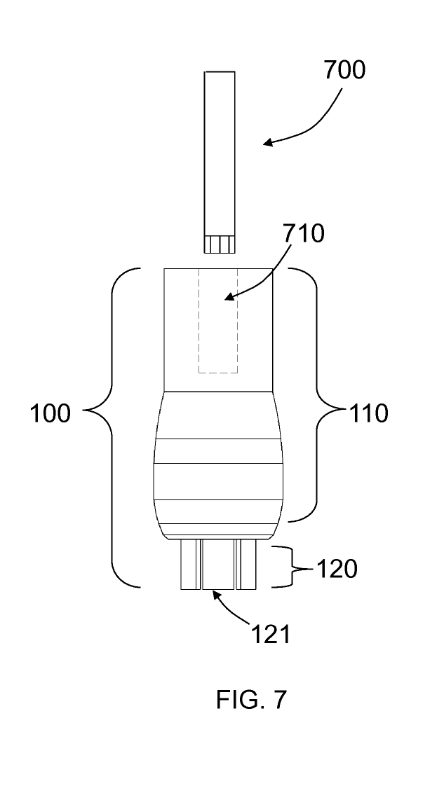

According to some embodiments of the invention, as illustrated in FIG. 7, the interface device 100 may be adapted to receive an extricating tool 700, which may facilitate in removing (extricating) the dental interface device 100 from the implant 150 and the dental abutment 200 along with the interface device, when necessary. For example, the extricating tool 700 may be a screwdriver, where the interface device 100 may have a female threaded cavity 710 at the edge of the device 100 that attaches to the abutment 200, enabling to receive the screwdriver extricating tool 700 and pulling the interface device 100 out of the implant 150 once the extricating tool 700 is threaded to the device's 100 cavity 710. Such an extricating tool 700 may also be, for example, an extricating bolt, a grasper and the like, where the cavity 710 of the interface device 100 is configured in correspondence to the type and shape of the extricating tool 700.

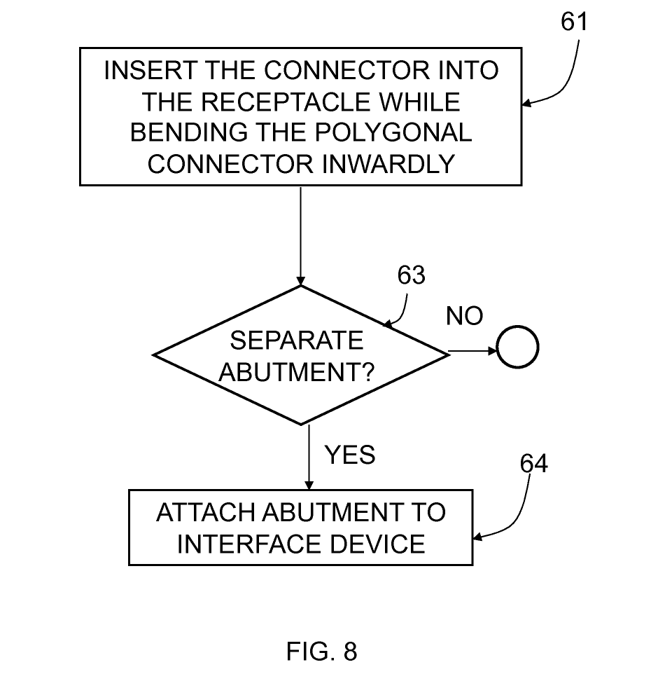

FIG. 8 is a flowchart illustrating a method for coupling of the dental interface device 100 of an abutment 200 to the dental implant 150, according to some embodiments of the invention. According to these embodiments, the method may comprise:
inserting 61 of the polygonal connector 120 into the cavity of the receptacle 151, wherein upon insertion, the sections 121 of the connector 120 are bent inwardly towards the main axis 10, thereby allowing an “interference fit” between the connector 120 and the implant 150.

The connector's 120 sections 121 may enable automatically retrieving to an unbent position once the connector 120 is inside the receptacle 151, wherein the outer walls of the sections 121 of the connector 120 may apply pressure against the inner walls of the receptacle 151, thereby securing the connector to the implant.

According to some embodiments of the invention, if the abutment 200 is separated 63 from the device 100 and designed to be attached after the interface device 100 has been coupled and fastened to the implant's 150 receptacle 151—the user (e.g. the dentist, assistant etc.) may then attach the abutment 200 and fasten it to the interface device 100 thereby connecting the abutment 200 to the implant 150 through the device 100.

According to some embodiments of the invention, the connector's 120 sections 121 may enable bending and then retrieving to an unbent position, where the pressure applied by the connector 120 upon the inner walls of the receptacle 150 may increase, once the sections 121 return to the unbent position coupling the connector 120 to the receptacle 150.

The dental interface device 100 and its corresponding abutment 200 and implant 150 may be considered a dental “system” in which the interface device 120 is connected to the abutment 200 at one end (either by connecting of two separate parts of as one integrally configured part) and enables fastening to the implant 150 by coupling the connector 120 to the receptacle 150.

According to some embodiments of the invention, the dental implant may already be endosseously seated in the patient's jawbone when the interface device is inserted into the implant's receptacle.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. A system comprising a dental interface device and a dental implant, wherein said dental interface device provides an interface between a corresponding abutment and said dental implant,
said dental interface device comprising:
a shank; and
a polygonal connector comprising a plurality of bendable sections that extend from a base of said shank, wherein the cross-section of said sections delineate a polygonal shape,
wherein said implant comprises a polygonal receptacle, which is a cavity designed to coaxially receive said polygonal connector of said device;
wherein the connector's outer dimensions create a polygonal shape that is slightly larger than the corresponding inner dimensions of the polygonal receptacle,
wherein said sections enable bending inwardly towards a main axis of said polygonal shape when inserted to said receptacle, and return towards an unbent position once the connector is inside the receptacle thereby applying pressure upon the inner walls of said receptacle, thereby securing said connector to said receptacle and implant.

2. The system of claim 1 wherein said sections are divided by cuts separating one section from an adjacent section.

3. The system of claim 2 wherein said cut of each said section extends vertically from the connector's end towards the base of the shank reaching said base.

4. The system of claim 2 wherein said cut of each said section extends vertically from the connector's end towards a part of the line directing towards the base.

5. The system of claim 1 wherein at least part of said connector comprises at least one of titanium and zirconium.

6. The system of claim 1, further comprising a tightening element for further securing the interface device to the implant's receptacle,
wherein said tightening element is longitudinal comprising a substantially conical taper, wherein each section of said interface device comprises at least one projection allowing to interlock with said taper, whereby said tightening element is fastened to said interface device; and
wherein said interface device comprises a longitudinal cavity allowing insertion of said element into said longitudinal cavity in such a way that when securing the tightening element into said cavity and into the receptacle of said implant the taper slides over the projections thereby causing the projections to be pressed against the inner walls of the sections and hence further pressing the sections against the inner walls of the receptacle whereby said interface device is fastened to said implant's receptacle.

7. The system of claim 1 wherein said interface device enables attaching to a dental abutment through fastening means.

8. The system of claim 1 wherein said sections are made from flexible solid material that allow a user to slight bend said section towards the main axis of the connector as well as the returning of said sections to the unbent position once said sections are inside said receptacle.

9. The system of claim 8 wherein said sections have a substantially roughened surface to facilitate in increasing friction between the connector and the inner walls of the implant's receptacle.

10. The system of claim 9 wherein the material from which said sections comprise at least one of rubber, flexible polymeric materials and silicone.

11. The system of claim 1 further comprising a cavity situated at the edge of said interface device that connects to the abutment, adapted to receive an extricating tool wherein said tool enables removing of said interface device from the implant.

12. The system of claim 11 wherein said tool is one of: an extricating bolt, screwdriver, pliers and a grasper and wherein said cavity is configured in correspondence to said tool.

13. The system of claim 1 wherein cuts separate each section from another adjacent section, wherein said cuts run from the bottom end of the connector towards the base of the shank.

14. The system of claim 1 wherein a cut separating each section from another adjacent section, wherein said cut runs from the corner of the connector and does not reach the base of the shank.

15. The system of claim 1 wherein the outer surface of the sections are tilted, creating an angle between each section of said device and the main axis of said device to facilitate in inserting of said device's connector to said implant's receptacle.

16. The system of claim 15 wherein said sections are tilted inwardly towards said axis.

17. The system of claim 15 wherein said sections are tilted outwardly from said axis.

18. The system of claim 1 wherein each of said sections have an angular external surface wherein each section comprises the angle of the polygon of said connector.

19. The system of claim 1 wherein each of said sections has a substantially flat external surface, wherein each section forms a side of the polygon of said connector.

20. A dental interface device that provides an interface between a corresponding abutment and an implant,
said interface device comprising:
a shank; and
a polygonal connector comprising of a plurality of bendable sections that extend from the base of said shank, wherein the cross-sectional view of said sections delineating a polygonal shape;
wherein said implant comprises a polygonal receptacle, which is a cavity designed to coaxially receive said polygonal connector of said device, wherein the outer dimensions of the polygonal shape of the connector are slightly larger than the corresponding inner dimensions of the polygonal receptacle,
wherein said sections enable bending inwardly towards the main axis of said connector thereby applying pressure upon the inner walls of said receptacle, thereby securing said connector to said receptacle and implant.

21. The device of claim 20 wherein a cut separating each section of said connector from another adjacent section runs from the corner of the connector towards the base of the shank.

22. The device of claim 20 wherein the outer surface of the top edges of the sections are tilted creating a non-flat angle between each section of said device and the main axis of said device to facilitate in inserting of said device's connector to said implant's receptacle.

23. A method for coupling of a dental interface device of an abutment to a dental implant, wherein said device comprises a shank and at least one connector comprised of sections configured in a polygonal shape and wherein said implant comprises at least one receptacle, which is a cavity designed to receive the sections of said connector,
said method comprising:
inserting of the polygonal connector into the cavity of the receptacle by bending of said sections inwardly towards a main axis of said interface device allowing the insertion of said connector into said receptacle;
wherein said connector's sections enable retrieving back to an unbent position once the connector is inside the receptacle, wherein the outer walls of the sections of the connector apply pressure against the inner walls of the receptacle securing the connector to the implant.

24. The method of claim 23 wherein the dental implant is already endosseously seated in the patient's jawbone when the interface device is inserted into the implant's receptacle.
